(19) United States
(12) Patent Application Publication
(10) Pub. No.: US 2007/0168407 A1
(43) Pub. Date: Jul. 19, 2007

(54) SNR estimation using filters

(75) Inventors: Rakesh Prasad, Bangalore (IN); Guha Venkatasubramanian Guru, Bangalore (IN)

Correspondence Address: Ashok Tankha,;Lipton, Weinberger & Husick, 36 Greenleigh Drive, Sewell, NJ, 08080, US

(73) Assignee: MobiApps, Inc., Arlington, VA (US)

(21) Appl. No.: 11/478,385

(22) Filed: Jun. 29, 2006

(30) Foreign Application Priority Data
Nov. 11, 2005 (IN) 1645/CHE/2005

(51) Int. Cl. G06F 17/10

(52) U.S. Cl. 708/300

(57) ABSTRACT

The present invention provides a method of accurately determining the signal to noise ratio (SNR) using filters. Three embodiments of the invention are disclosed: the use of fixed filters, multiple filters and dynamic filters. The total noise energy is calculated by applying low pass and high pass filters. The minimum of the two noise energies estimated by the low pass and high pass filters is selected to calculate the total noise energy in the signal. The present invention provides an accurate method of SNR estimation in conditions of low SNR and high carrier offsets, without the requirement for bringing the signal to base band. The use of multiple filters provides accurate SNR measurement even in the presence of discrete interferences.

### BACKGROUND OF THE INVENTION

The present invention, in general, relates to the estimation of signal to noise ratio (SNR) in digital communication receivers and specifically relates to SNR estimation using fixed, dynamic and multiple filters in the applications of low earth orbit (LEO) communication satellites.

The accurate estimation of SNR is a critical requirement in satellite communications applications. SNR estimation is required for the monitoring of impairments in the received signal in digital mobile radio systems and satellite modems. A typical satellite communications receiver or a digital mobile receiver is activated only at predetermined SNR thresholds. When the minimum SNR level is reached, the satellite communications receiver or a digital mobile receiver is switched on. The SNR value indicates whether the target satellite is within the permissible range of the receiver.

The methods in the art for SNR estimation are effective in medium (approximately 12 dB) to high SNR conditions. However, in the case of satellite modem applications in low SNR conditions, the relative strength of noise is high, hence the methods currently used in the art yield inaccurate results in SNR estimation.

Methods in the art for SNR estimation require the signal to be completely brought to base band. In satellite communication applications, it is difficult to bring the signal to base band, since there will be an uncertainty in the frequency estimation of the signal due to the Doppler shift induced by the high velocity of the LEO satellites.

Carrier offsets resulting from Doppler shifts are a recurring problem in LEO satellite communication systems. The methods disclosed in the art for SNR estimation typically fail in the presence of carrier offsets.

Discrete interference external radiation sources result in non-uniformity in the pattern of noise energy. The methods disclosed in the art for SNR estimation typically fail in the presence of discrete interferences.

Hence, there is an unsatisfied market need for an accurate method for SNR estimation, that can be effectively applied in conditions of low SNR and high carrier offsets, and that does not require the signal to be brought to base band. There is also an unsatisfied market need for an accurate method of SNR estimation in the presence of discrete interferences.

### SUMMARY OF THE INVENTION

The present invention provides a method of accurately determining SNR using filters. The following three embodiments of the invention are disclosed: a method for accurately determining SNR using fixed filters, multiple filters and dynamic filters. The noise energy value is calculated by applying low pass and high pass filters. The minimum amongst the energy values estimated by the low pass and high pass filters, is selected to calculate the actual noise energy in the signal. The present invention provides an accurate method for SNR estimation in conditions of low SNR and high carrier offsets, and also provides a method that does not require the signal to be brought to base band. The use of multiple filters provides an accurate SNR measurement even in the presence of discrete interferences.

This invention proposes a method of filter selection and application and a method of SNR computation. The method of this invention, including all its embodiments will be hereafter referred to as the selective filter application (SFA) method.

One advantage of the SFA method is that SNR is accurately estimated even in the conditions of extreme frequency variations. Extreme frequency variations typically exist in the signals received from LEO satellites. The Doppler shift varies significantly in the signals transmitted by LEO satellites, for example, from −3000 Hz to +3000 Hz, varying at a maximum rate of 27 Hz/sec.

Another advantage of the SFA method is that SNR is accurately estimated even in low SNR conditions.

Another advantage of the SFA method is that SNR is accurately estimated even in the presence of high carrier offsets.

Another advantage of the SFA method is that it can be used for different types of modulation schemes, such as binary phase shift keying (BPSK), M-ary phase shift keying (mPSK), M-ary frequency shift keying (mFSK), and differential modulation schemes.

Another advantage of the SFA method is that the signal does not have to be brought to base band for SNR estimation.

### BRIEF DESCRIPTION OF THE DRAWINGS

FIG. 1A illustrates the graphical representation of the equation 2W+W_{sig}≦fₛ/2 for the first embodiment of the invention that uses a fixed filter low pass and high pass filter.

FIG. 1B illustrates the intersection of signal and filter spectra that occurs when the equation 2W+W_{sig}≦fₛ/2 is not satisfied.

FIG. 1C illustrates the signal and filter spectrum for the second embodiment of the invention that uses dynamic filters.

FIG. 1D illustrates an example of a sampled signal spectrum with discrete interferences.

FIG. 1E illustrates the application of the first multiple filter to the signal spectrum.

FIG. 1F illustrates the application of the second multiple filter to the signal spectrum.

FIG. 1G illustrates the application of the third multiple filter to the signal spectrum.

FIG. 1H illustrates the application of the fourth multiple filter to the signal spectrum.

FIG. 1I illustrates the original signal spectrum.

FIG. 1J is a representation of the outputs of the multiple filters as illustrated in FIG. 1E, FIG. 1F, FIG. 1G, FIG. 1H and the original signal spectrum shown in FIG. 1I.

FIG. 2 illustrates the method of SNR computation.

FIG. 3A illustrates a graph that compares the SNR estimated by the proposed SFA method with the methods of prior art for a quadrature phase shift keying (QPSK) modulated base band signal at 10 Hz frequency offset.

FIG. 3B illustrates a graph that compares the SNR estimated by the proposed SFA method with the methods of prior art for a QPSK modulated base band signal at 1000 Hz frequency offset.

FIG. 4A illustrates a graph that compares the SNR estimated using the SFA method with the SNR estimated using a method of prior art for a symmetrical differential phase shift keying (SDPSK) modulated base band signal at 0 Hz frequency offset.

FIG. 4B illustrates a graph that compares the true SNR with the estimated SNR using the SFA method for a SDPSK modulated base band signal at a high frequency offset of 1000 Hz.

### DETAILED DESCRIPTION OF THE INVENTION

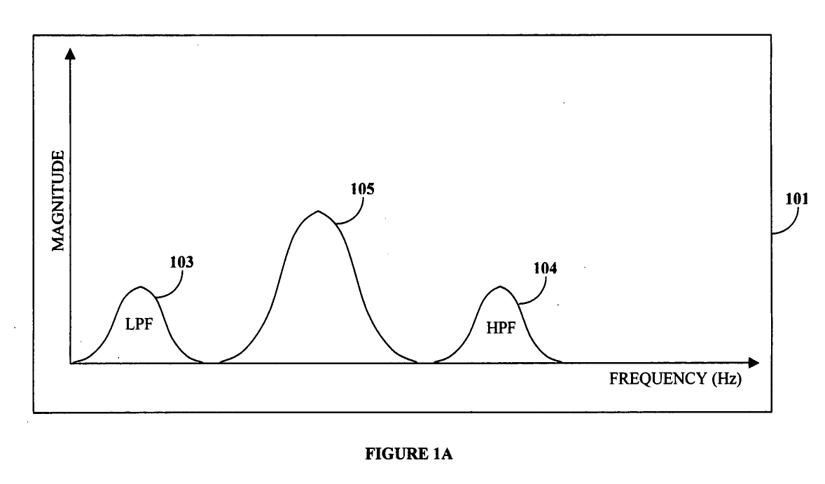

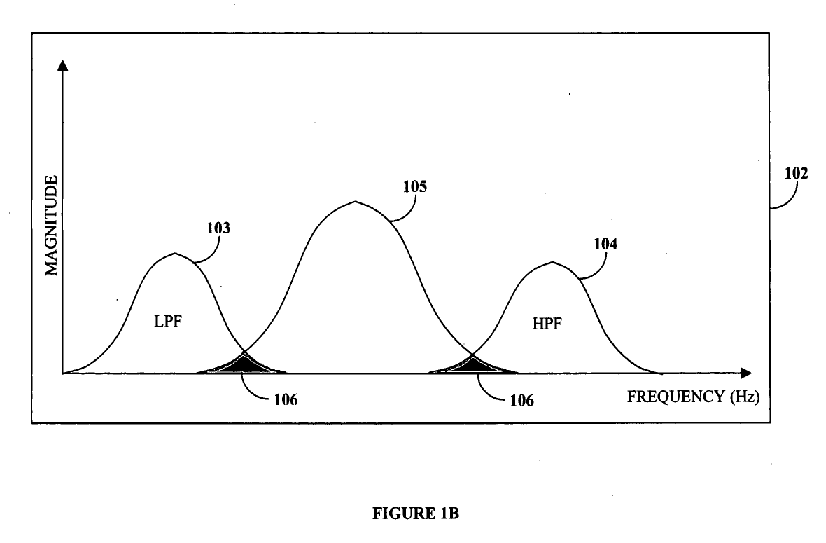

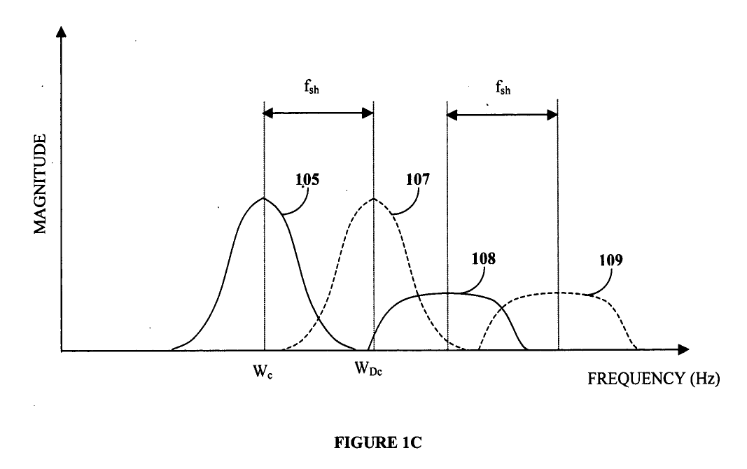

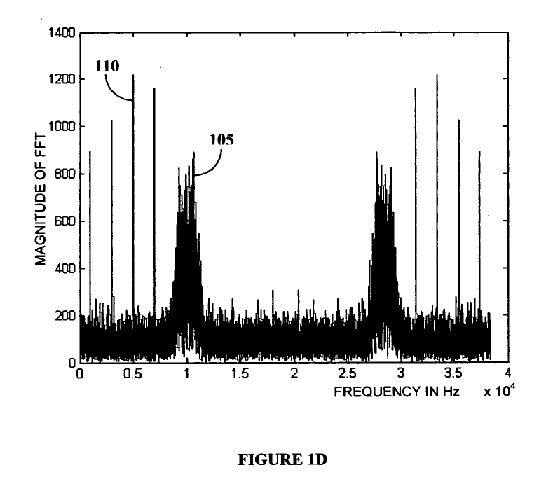

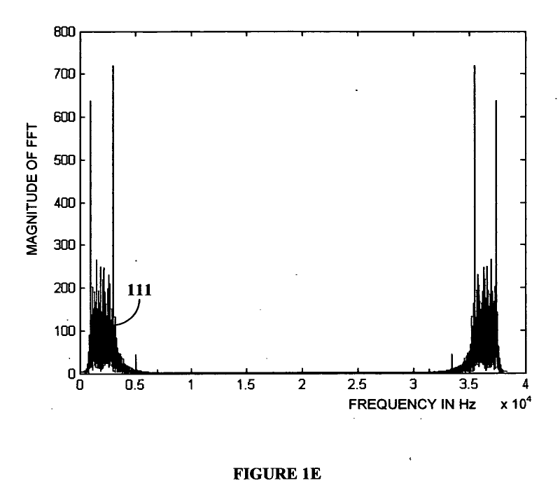

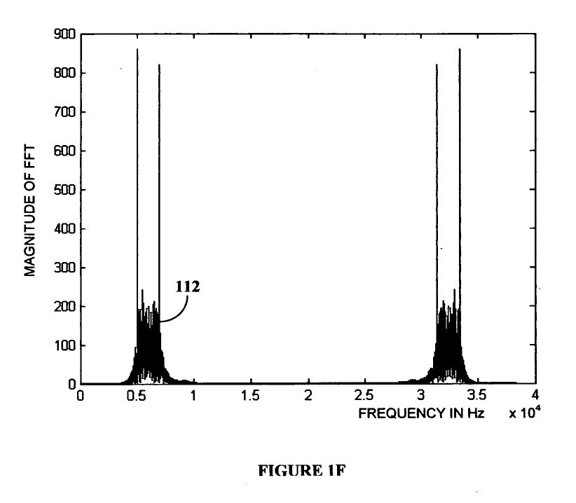

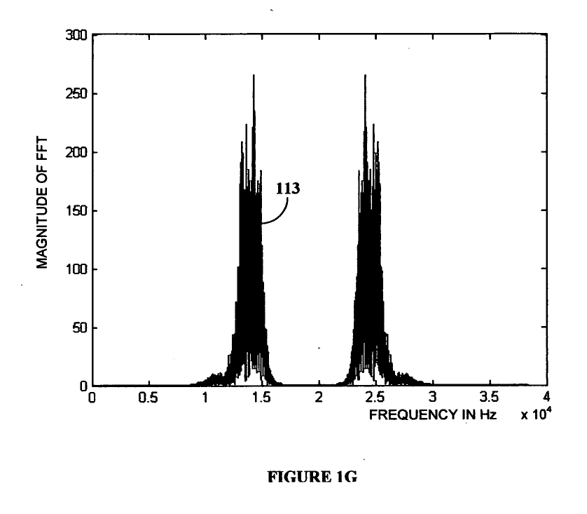

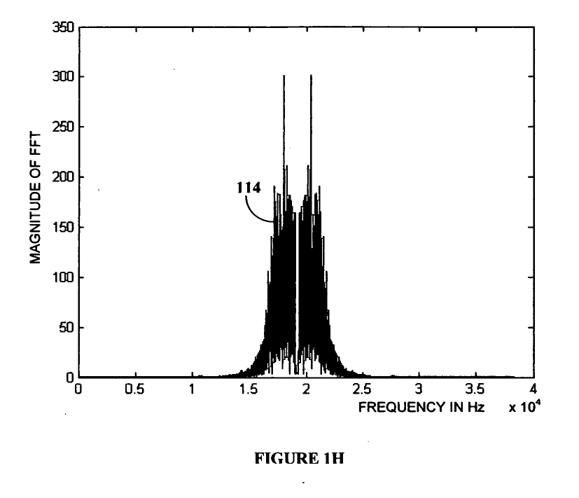

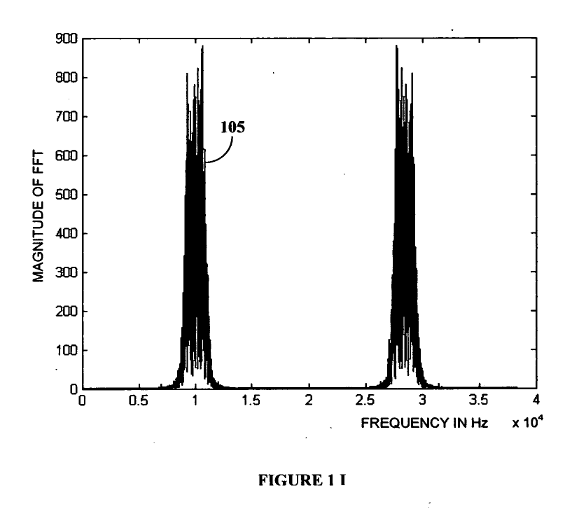

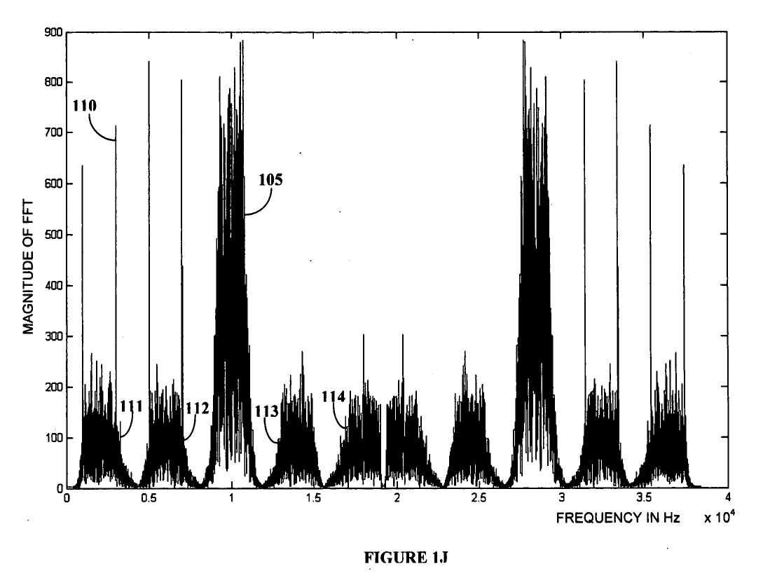

FIG. 1A illustrates the graphical representation 101 of the equation 2W+W_{sig}≦fₛ/2 for the first embodiment of the invention that uses a fixed filter at both ends of the signal spectrum 105. The sampling rate, abbreviated as fₛ, is determined by an analog to digital converter (ADC). The bandwidth of the low pass 103 and high pass 104 filters are fixed at W Hz. The maximum signal bandwidth required is assumed to be W_{sig} Hz. The bandwidth W of the low and high pass frequency bands are selected such that the spectrum of one of those filters does not intersect with that of the incoming signal 105. This is ensured by compliance to the equation:
2W+W_{sig}≦fₛ/2

FIG. 1B illustrates the graphical representation 102 intersection of signal spectrum 105 and filter spectra 103, 104 that occurs when the equation 2W+W_{sig}≦fₛ/2 is not satisfied. Ideally at least one of the two filters, i.e., either the low pass filter 103 or high pass filter 104 must estimate only the noise energy and should not estimate the energy in any section of the signal spectrum 105. However, when the signal spectrum 105 and filter spectrum 103, 104 intersect as illustrated in FIG. 1B when the equation 2W+W_{sig}≦fₛ/2 is not satisfied, both the high pass 104 and low pass filters 103 estimate not only the noise, but also a section of the signal spectrum 105, as depicted by the shaded areas 106.

FIG. 1C illustrates the signal spectrum 105 and dynamic filter spectrum 108 for the second embodiment of the invention that uses dynamic filters 108. When the characteristics of the signal 105 change to signal 107 due to frequency shift, the filter 108 dynamically shifts to a new position 109.

The center frequency W_{c} of the received signal is estimated by the receiver. The bandwidth of the filter (B) is also known, for example B can be equal to signal bandwidth W_{sig}. For a modulated signal, W_{sig}=B+α B, where B is the baud rate and α is the roll off factor of the pulse shaping filter.

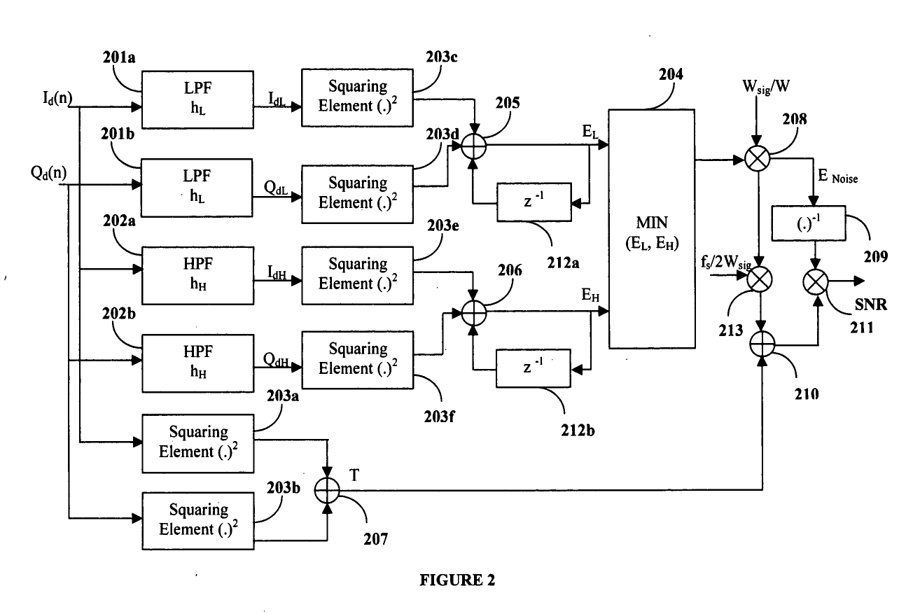

A single dynamic filter 108 is used at one end of the signal spectrum 105 for noise energy estimation. The same method, as illustrated under the description of FIG. 2 is applied for the estimation of SNR using dynamic filters.

When the center frequency of the signal 105 shifts to a new position 107 as illustrated in FIG. 1C, the filter response shifts correspondingly 109 and thereby, overlap of the shifted filter response 109 with the actual signal 105 is avoided.

A method for deriving a dynamic filter is given below. The filter coefficients of the dynamic filter are calculated. The dynamic filter is defined by its filter coefficients. The following values are known: bandwidth of the filter B, center frequency of the original signal W_{C}, frequency shift fₛₕ, shift in center frequency of the signal W_{DC} and sampling duration Tₛ. The objective is to derive the filter coefficients, thereby creating the dynamic filter.

Given the center frequency W_{C} and the frequency shift fₛₕ of the original signal, the center frequency of the shifted signal is defined by the equation,
W_{DC}=W_{C}+fₛₕ

The design and application of a dynamic filter comprises of first creating a filter and shifting it appropriately as the original signal shifts.

The following example describes the method of creating a Butterworth filter and dynamically shifting it. Note that this invention is not restricted to the use of a particular type of filter, such as the filter provided below. The filter coefficients of a second order Butterworth band pass filter are given as n₀, n₁, n₂, d₀, d₁ and d₂. Tₛ is the sampling duration and B is the bandwidth of the filter.
C=cot(W_{DC}×Tₛ/2)
n₀=B.C
n₁=0
n₂=−B.C
d₀=B.C+C²+1
d₁=−2(C²−1)
d₂=−B.C+C²+1

The filter transform function H(z) is given as,
H(z)=(n₀+n₁z⁻¹+n₂z⁻²)/(d₀+d₁ z⁻¹+d₂z⁻²)

When the center frequency of the original signal shifts, the frequency shift is known and accordingly the dynamic filter parameters are determined. After the dynamic filter is applied to the signal spectrum, E_{Noise} is determined by computing the dynamic filter output.

FIG. 1D illustrates an example of a sampled signal spectrum 105 with discrete interferences. Discrete interferences to the signal cause non-uniform noise 110 in the frequency domain. However, the non-uniform noise 110 or discrete interferences in the frequency domain may or may not reside in the signal spectrum 105.

FIG. 1E illustrates the application of the first multiple filter 111 to the signal spectrum 105.

FIG. 1F illustrates the application of the second multiple filter 112 to the signal spectrum.

FIG. 1G illustrates the application of the third multiple filter 113 to the signal spectrum.

FIG. 1H illustrates the application of the fourth multiple filter 114 to the signal spectrum.

FIG. 1I illustrates the original signal spectrum 105.

FIG. 1J is a representation of the outputs of the multiple filters as illustrated in FIG. 1E, FIG. 1F, FIG. 1G, FIG. 1H and the original signal spectrum 105 shown in FIG. 1I.

Consider the case of a discrete interference or a non uniform noise 110 illustrated in FIG. 1D. Consider the case when M multiple filters are used. The actual white noise energy E_{Noise} is best represented by the filter that measures the least energy.
E_{Noise}=[W_{sig}/w](min(E₁,E₂ . . . E_{M}))
where W_{sig} is the maximum signal bandwidth, M is the number of multiple filters, w is the bandwidth of each multiple filter, and E₁, E₂ . . . E_{M} are the noise values estimated by the filters.

FIG. 2 illustrates the method of computation of SNR. The in-phase sample I_{d}(n) of the incoming signal is passed through a low pass filter 201a, while the quadrature phase sample Q_{d}(n) is passed through another low pass filter 201b, both the filters having a bandwidth W. I_{dL} is the in-phase sample of the digital signal after the application of the low pass filter 201a to the in-phase sample I_{d}(n) of the sampled signal. Q_{dL} is the quadrature phase sample after the application of the low pass filter 201b to the quadrature phase sample Q_{d}(n) of the sampled signal.

The application of the filters is illustrated by the following equations:
I_{dL}=I_{d}*h_{L},
Q_{dL}=Q_{d}*h_{L}
where h_{L} is the filter coefficient and * represents convolution.

The relation between the input χₙ and the output yₙ of the filter is given by the equation:
(yₙ×b₀)+(yₙ₋₁×b₁)+(yₙ₋₂×b₂)+ . . . =(χₙ×a₀)+(χₙ₋₁×a₁)
where a₀, a₁, . . . , and b₁, b₂ . . . are filter coefficients.

The filter may be of infinite impulse response (IIR) or finite impulse response (FIR). The output in frequency domain is given by:
Ĩ_{dL}(w)=H(w)×Ĩ_{d}(w)
\tilde{Q}_{dL}(w)=H(w)×\tilde{Q}_{d}(w)

The outputs of the low pass filter 201a and 201b are fed to the squaring elements 203c and 203d respectively, that square both the in-phase I_{dL} and quadrature phase Q_{dL} low pass filtered samples. The low pass signal energy (E_{L}) is obtained by summing the squares of the quadrature phase sample of the noise energy and the in-phase sample of the noise energy in a summer 205. The summer is fed with a one step delay z⁻¹ 212a. The summing operation is illustrated by the following equation

$${E}_{L} = {\sum }_{P = 0}^{P - 1} {I}_{dL}^{2} [ p ] + {Q}_{dL}^{2} [ p ]$$

wherein, p is the time index with a predetermined limit.

The in-phase sample I_{d}(n) of the incoming signal is passed through a high pass filter 202a, while the quadrature phase samples Q_{d}(n) is passed through another high pass filter 202b, both the filters having a bandwidth W. I_{dH} is the in-phase sample of the digital signal after the application of the high pass filter 202a, while Q_{dH} is the quadrature phase sample after the application of the high pass filter 202b.

Application of the filters is illustrated by the following equation:
I_{dH}=I_{d}*h_{H}
Q_{dH}=Q_{d}*h_{H}
where h_{H} is the filter coefficient of the high pass filter.

Outputs of the high pass filters 202a and 202b are fed to the squaring elements 203e and 203f respectively, that square both the in-phase and quadrature phase high pass filtered output samples. The high pass signal energy (E_{H}) is obtained by summing the squares of the quadrature phase samples of the noise energy and the in-phase sample of the noise energy in a summer 206. The summer is also fed with one step delay z⁻¹ 212b.

$${E}_{H} = {\sum }_{n = 0}^{n - 1} {I}_{dH}^{2} [ n ] + {Q}_{dH}^{2} [ n ]$$

Wherein n is the time index with a predetermined limit.

The minimum of the low pass signal energy and high pass signal energy is determined. This minimum is represented by min (E_{L}, E_{H}) 204. The minimum is chosen because if any one of the two low pass filters 201a or 201b, or the high pass filters 202a or 202b, filters a section of the actual signal along with the noise. That particular filter will provide a higher value for noise compared to the filter that filters only the noise. Hence, the minimum of E_{L} and E_{H} 204 is the most representative of the noise energy without discrete components. In case there is a discrete noise component, which comes in the region of the low or high pass filters, the minimum value of E_{L} and E_{H} ensures that the discrete noise is not measured.

The minimum of E_{L} and E_{H} 204 is fed to the distributor 208. The ratio of maximum signal bandwidth W_{sig} to bandwidth W of the high pass filters 202a or 202b and the low pass filters 201a or 201b, W_{sig}/W is also fed to the distributor 208.

Assuming additive white noise, the total noise energy (E_{Noise}) is calculated by the formula:
E_{Noise}=W_{sig}/W[min(E_{L},E_{H})]

The in-phase I_{d} (n) and quadrature phase Q_{d} (n) samples are fed to the squaring elements 203a and 203b respectively. The squared samples are summed using a summer 207.
The total energy of the incoming signal T is represented by

$$T = {\sum }_{K = 0}^{N - 1} {I}_{d}^{2} [ k ] + {Q}_{d}^{2} [ k ]$$

where I_{d} [k] and Q_{d} [k] are the in-phase and quadrature phase samples of the incoming signal respectively.

The total noise energy (E_{Noise}) is subtracted 210 from the energy of the received signal (T). The output of this operation provides the actual signal energy (S).
S=T−(fs/2)*E_{Noise}/Wsig

The calculated total noise energy (E_{Noise}) is fed to an inverter 209 in order to determine 1/E_{Noise}, and is forwarded to a distributor 211. The actual signal energy (S) is also fed to the distributor 211. The signal to noise ratio (SNR) determined at the distributor 211 is the ratio of actual signal energy (S) to the total noise energy (E_{Noise}).
SNR=S/E_{Noise}

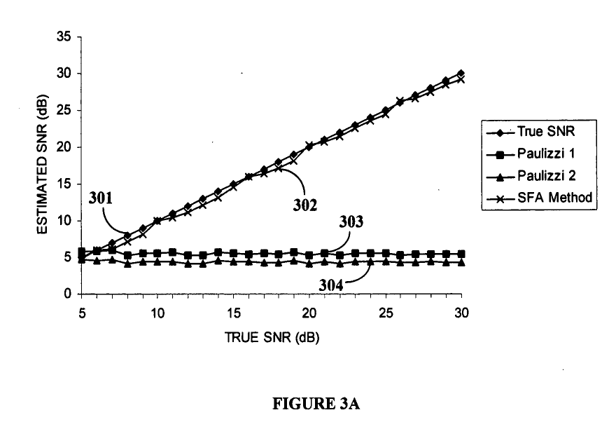

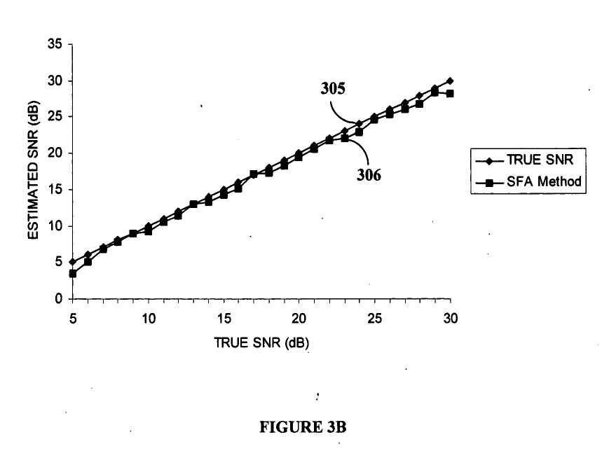

FIG. 3A illustrates a graph that compares the SNR estimated by the SFA method with two methods known in the art for a quadrature phase shift keying (QPSK) modulated base band signal at 10 Hz frequency offset. The two methods in the art are the SNR estimator techniques of Paulizzi's, et al., illustrated as equations (3) and (4) in the literature “A Comparison of SNR Estimation Techniques for QPSK Modulations” by David R. Pauluzzi, Andrew S. Toms and Norman C. Beaulieu, IEEE Transactions on Communications, Vol. 4, No. 2, February 2000. The plots of the two equations (3) and (4) are depicted as plot 303 and 304 in FIG. 3A. It can be observed from FIG. 3A that the above two methods yield SNR measurements that significantly deviate from the true SNR values. Plot 302 of the SFA method lies closest to the true SNR plot 301, even at low SNRs.

FIG. 3B illustrates a graph that compares the SNR estimated by the proposed SFA method with the true SNR for a QPSK modulated base band signal at a 1000 Hz frequency offset. It is observed that even at high frequency offsets, the plot 306 of the SFA method lies closest to the true SNR plot 305. Note that the prior art is not plotted in FIG. 3B as it significantly fails in the accuracy of SNR estimation.

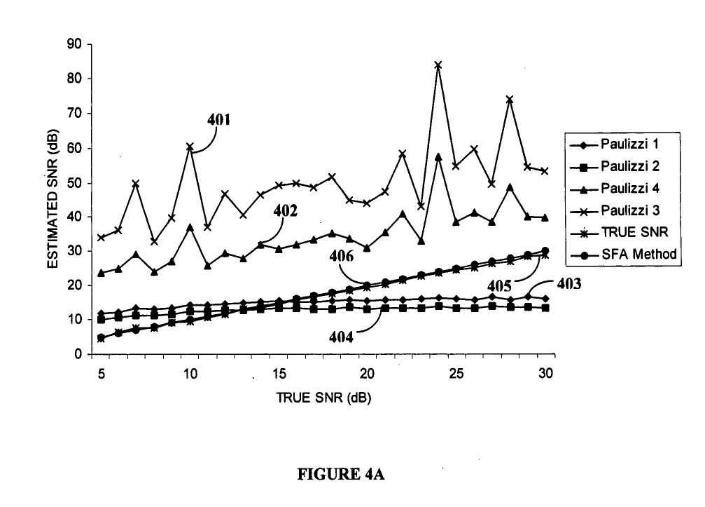

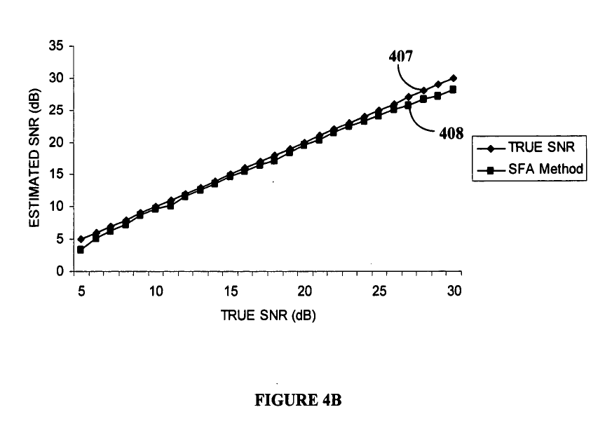

FIG. 4A illustrates a graph that compares the SNR estimated using the SFA method against the SNR estimated using a method in the art for a symmetrical differential phase shift keying (SDPSK) modulated base band signal at 0 Hz frequency offset. The four methods in the art considered are the SNR estimator techniques of Pauluzzi et al., illustrated as equations (3), (4), (5) and (6) “A Comparison of SNR Estimation Techniques for QPSK Modulations” by David R. Pauluzzi, Andrew S. Toms and Norman C. Beaulieu, IEEE Transactions on Communications, Vol. 4, No. 2, February 2000”. The results of the method using equation (3) disclosed above by Paulizzi, et al. is depicted as plot 403, the result of the method using equation (4) is depicted as 404, the result of the method using equation (5) is depicted as plot 401 in FIG. 4A and the result of the method using equation (6) is depicted as plot 402. It can be observed from FIG. 4A that the plot of the SFA method 406 of this invention lies closest to the true SNR 405.

FIG. 4B illustrates a graph that compares true SNR against the SNR estimated using the SFA method for a SDPSK modulated base band signal at a high frequency offset of 1000 Hz. It can be observed from FIG. 4B that the plot 408 of the SFA method of this invention lies very close to the true value of the true SNR 407.

In summary, it can be observed from FIG. 3A, FIG. 3B, FIG. 4A and FIG. 4B that the SFA method provides an accurate estimation of SNR, and the accuracy is not significantly affected by low SNR and high frequency offset conditions.

1. A method of estimating the signal to noise ratio of a sampled signal, comprising the steps of:
determining the bandwidth W of a low pass filter and the bandwidth W of a high pass filter from the relation 2W+W_{sig}≦fₛ/2, where W_{sig} is the maximum bandwidth of the sampled signal and fₛ is the sampling rate at which an analog signal is sampled to derive said sampled signal;
estimating a first noise energy value by applying said low pass filter and estimating a second noise energy value by applying said high pass filter to the sampled signal;
determining the minimum noise energy value amongst said first noise energy value and said second noise energy value;
calculating the noise energy within the signal using said minimum noise energy value; and
estimating the received signal energy and computing the signal to noise ratio as a ratio of said actual signal energy to the noise energy in the signal.

2. A method of estimating the signal to noise ratio of a sampled signal, comprising the steps of:
estimating the noise energy by applying a dynamic filter to said sampled signal, wherein the center frequency of the filter is dynamically shifted;
calculating the noise energy value in the sampled signal;
estimating the received signal energy; and
estimating the actual signal energy from said received signal energy by subtracting the noise energy value and computing the signal to noise ratio as a ratio of said actual signal energy to the noise energy in the sampled signal.

3. A method of estimating the signal to noise ratio of a sampled signal, comprising the steps of:
applying multiple filters and determining the value of the noise energy measured by each of said multiple filters;
determining the lowest value of the noise among the noise energies measured by said multiple filters;
calculating the noise energy in said sampled signal using said lowest value of noise; and
estimating the received signal energy and computing the actual signal energy by subtracting the noise energy in the sampled signal from said received signal energy and computing the signal to noise ratio as a ratio of said actual signal energy to the noise energy in the signal.

4. The method of claim 1, wherein the step of estimating said first noise energy by applying said low pass filter of bandwidth W to the sampled signal, further comprises the steps of:
computing the quadrature phase energy value of the first noise energy by applying the low pass filter to said quadrature phase sample of the sampled signal;
computing the in-phase sample of the first noise energy by applying the low pass filter to said in-phase sample of the sampled signal; and,
computing the first noise energy by summing the squares of the said quadrature phase energy value of the first noise energy and said in-phase energy value of the first noise energy.

5. The method of claim 1, wherein the step of estimating said second noise energy by applying said high pass filter of bandwidth W to the sampled signal, further comprises the steps of:
computing the quadrature phase sample of the second noise energy by applying the high pass filter to said quadrature phase sample of the sampled signal;
computing the in-phase sample of the second noise energy by applying the high pass filter to said in-phase sample of the sampled signal; and
computing the second noise energy by summing the squares of the said quadrature phase sample of the second noise energy and said in-phase sample of the second noise energy.

6. The method of claim 1, wherein the step of determining the total noise energy applies the equation:
E_{Noise}=[W_{sig}/W]min(E_{L},E_{H})
where W_{sig} is the maximum signal bandwidth, W is the bandwidth of the low pass and high pass filters, E_{L} is the first noise energy, E_{H} is the second noise energy, and min (E_{L}, E_{H}) is the minimum value of said first noise energy and said second noise energy.

7. The method of claim 3, wherein the step of determining the total noise energy comprises:
applying the equation E_{Noise}=[W_{sig}/W] (min (E₁, E₂ . . . E_{M}))
where W_{sig} is the maximum signal bandwidth, M is the number of multiple filters, W is the bandwidth of each of the multiple filters and E₁, E₂ . . . E_{M} are the noise values estimated by the filters.
